(19) United States
(12) Patent Application Publication
(10) Pub. No.: US 2018/0050341 A1
(43) Pub. Date: Feb. 22, 2018

(54) POULTRY LITTER CONDITIONER AND ATTACHMENT ASSEMBLY

(71) Applicant: Howard C. Popp, Rice, MN (US)

(72) Inventor: Howard C. Popp, Rice, MN (US)

(21) Appl. No.: 15/242,168

(22) Filed: Aug. 19, 2016

(51) Int. Cl. B02C 13/06; A01K 31/04; A01K 1/015

(52) U.S. Cl. CPC B02C 13/06; A01K 1/015; A01K 31/04

(57) ABSTRACT

A poultry litter conditioner includes a motor, a shaft configured to be rotated by the motor, and a plurality of beater elements attached to the shaft, and a tunnel assembly that includes a hood, a left endplate, and a right endplate. The poultry litter conditioner also includes an attachment assembly that includes a mounting plate configured to attach to a skid steer, first and second lower support members and first and second upper support members, each coupled to the mounting plate and to the tunnel assembly. The first and second upper support members are respectively coupled to the tunnel assembly via respective ball-and-socket connections, where the respective ball-and-socket connections include a respective bolt and a respective bracket that defines a respective slot, where at least a portion of the respective bolt is slidably disposed within the respective slot. The respective brackets are attached to the tunnel assembly.

### TECHNICAL FIELD

This document generally describes poultry litter conditioners, and devices, methods and systems for attaching a poultry litter conditioner, or other machines or tools, to a skid steer.

### BACKGROUND

Poultry barns are typically large structures that can house many hundreds or thousands of birds, such chickens or turkeys, or other poultry such as pheasants, ducks, geese, and the like. Some poultry barns include a concrete floor, but many poultry barns include a dirt floor.

Typically, a poultry litter comprised of a mixture of poultry bedding material, spilled feed, feathers, and poultry excreta or poultry manure rests on the floor of the poultry barn. Occasionally, the poultry litter can be completely removed from the barn and replaced with a fresh layer of poultry bedding, but this can involve significant effort and cost. The poultry litter may be periodically reconditioned, which may extend the life of the poultry litter and may reduce a number of complete litter replacements that may be needed. One example of a poultry litter conditioner is pulled behind a tractor.

A skid steer, skid-steer, skid-steer loader, or skid loader is an engine-powered machine that includes lift arms. A variety of machines that can be used to perform tasks may be attached to the lift arms of the skid steer.

### SUMMARY

In a first general aspect, a poultry litter conditioner includes a tunnel assembly that includes a hood, a left endplate, and a right endplate. The poultry litter conditioner also includes a motor, a shaft configured to be rotated by the motor, and a plurality of beater elements attached to the shaft, where a majority of the shaft is disposed between the left endplate and the right endplate. The poultry litter conditioner further includes an attachment assembly that includes a mounting plate configured to attach to a skid steer, where the attachment assembly further includes first and second lower support members, each coupled to the mounting plate and to the tunnel assembly, and includes first and second upper support members, each coupled to the mounting plate and to the tunnel assembly. The first upper support member is coupled to the tunnel assembly via a first ball-and-socket connection, where the first ball-and-socket connection includes a first bolt and a first bracket that defines a first slot, where at least a portion of the first bolt is slidably disposed within the first slot. The first bracket is attached to the tunnel assembly. The second upper support member is coupled to the tunnel assembly via a second ball-and-socket connection, where the second ball-and-socket connection includes a second bolt and a second bracket that defines a second slot, where at least a portion of the second bolt is slidably disposed within the second slot. The second bracket is attached to the tunnel assembly.

Various implementations may include one or more of the following. The tunnel assembly may further include a support bar, and each of the first bracket and the second bracket may be attached to the support bar. The first upper support member may be coupled to the mounting plate via a third ball-and-socket connection, and the second upper support member may be coupled to the mounting plate via a fourth ball-and-socket connection. The first lower support member may be coupled to the mounting plate via a third bracket and a third bolt, and the first lower support member may be able to pivot about the third bolt until a portion of the first lower support member contacts the mounting plate; the second lower support member may be coupled to the mounting plate via a fourth bracket and a fourth bolt, and the second lower support member may be able to pivot about the fourth bolt until a portion of the second lower support member contacts the mounting plate. The hood of the tunnel assembly may include a first forward surface and a first rearward surface that are joined at an apex of the hood; the hood may further include a second forward surface contiguous with the first forward surface, and may include a second rearward surface contiguous with the first rearward surface; the tunnel assembly may further include a third forward surface contiguous with the second forward surface, and may include a third rearward surface contiguous with the second rearward surface. The first forward surface and the first rearward surface may intersect at a first obtuse angle; the first forward surface and the second forward surface may intersect at a second obtuse angle; the first rearward surface and the second rearward surface may intersect at a third obtuse angle; the second forward surface and the third forward surface may intersect at a fourth obtuse angle; and the second rearward surface and the third rearward surface may intersect at a fifth obtuse angle. First ends of each of the first, second and third forward surfaces and first, second and third rearward surfaces may be attached to the left endplate, and second ends of each of the first, second and third forward surfaces and first, second and third rearward surfaces may be attached to the right endplate. The mounting plate may be configured to attach to one or more lift arms of the skid steer. The mounting plate may be configured to attach to a plate that is attached to one or more lift arms of the skid steer. The poultry litter conditioner may further include a first height-adjust plate attached to the left endplate, and may include a second height-adjust plate attached to the right endplate, where a height of the tunnel assembly may be adjustable by setting a position of the first height-adjust plate with respect to the left endplate and by setting a position of the second height-adjust plate with respect to the right endplate. The poultry litter conditioner may further include first and second replaceable wear bars, the first replaceable wear bar attached to a lower portion of the first height-adjust plate and the second replaceable wear bar attached to a lower portion of the second height-adjust plate. The first slot defined by the first bracket may have a horizontal orientation, and the second slot defined by the second bracket may have a horizontal orientation.

In a second general aspect, a poultry litter conditioner includes a tunnel assembly that includes a hood, a left endplate, and a right endplate. The poultry litter conditioner also includes a motor, a shaft configured to be rotated by the motor, and a plurality of beater elements attached to the shaft, where a majority of the shaft is disposed between the left endplate and the right endplate. The poultry litter conditioner further includes an attachment assembly that includes a mounting plate configured to attach to a skid steer. The attachment assembly also includes first and second lower support members, each coupled to the mounting plate and to the tunnel assembly, and includes an upper support member coupled to the mounting plate and to the tunnel assembly. The upper support member is coupled to the tunnel assembly via a ball-and-socket connection that includes a bolt and a bracket that defines a slot, where at least a portion of the bolt is slidably disposed within the slot, and where the bracket is attached to the tunnel assembly.

Various implementations may include one or more of the following. The tunnel assembly may further include a support bar, and the first bracket may be attached to the support bar. The upper support member may be coupled to the mounting plate via a second ball-and-socket connection. The first lower support member may be coupled to the mounting plate via a second bracket and a second bolt, and the first lower support member may be able to pivot about the second bolt until a portion of the first lower support member contacts the mounting plate; the second lower support member may be coupled to the mounting plate via a third bracket and a third bolt, and the second lower support member may be able to pivot about the third bolt until a portion of the second lower support member contacts the mounting plate.

In a third general aspect, a poultry litter conditioner includes a tunnel assembly that includes a hood, a left endplate, and a right endplate. The poultry litter conditioner further includes a motor, a shaft configured to be rotated by the motor, and a plurality of beater elements attached to the shaft, where a majority of the shaft is disposed between the left endplate and the right endplate. The poultry litter conditioner also includes an attachment assembly that includes a mounting plate configured to attach to a skid steer. The attachment assembly also includes a lower support member coupled to the mounting plate and to the tunnel assembly, and includes first and second upper support members, each coupled to the mounting plate and to the tunnel assembly. The first upper support member is coupled to the tunnel assembly via a first ball-and-socket connection, where the first ball-and-socket connection includes a first bolt and a first bracket that defines a first slot. At least a portion of the first bolt is slidably disposed within the first slot, and the first bracket is attached to the tunnel assembly. The second upper support member is coupled to the tunnel assembly via a second ball-and-socket connection, where the second ball-and-socket connection includes a second bolt and a second bracket that defines a second slot. At least a portion of the second bolt is slidably disposed within the second slot, and the second bracket is attached to the tunnel assembly.

Various implementations may include one or more of the following. The tunnel assembly may further include a support bar, and each of the first bracket and the second bracket may be attached to the support bar. The first upper support member may be coupled to the mounting plate via a third ball-and-socket connection, and the second upper support member may be coupled to the mounting plate via a fourth ball-and-socket connection. The lower support member may be coupled to the mounting plate via a third bracket and a third bolt, and the lower support member may be able to pivot about the third bolt until a portion of the lower support member contacts the mounting plate.

### BRIEF DESCRIPTION OF THE DRAWINGS

FIGS. 1A and 1B are perspective views of an example poultry litter conditioner and a skid steer, where the example poultry litter conditioner is attached to the skid steer with an example attachment assembly.

FIG. 2 is a perspective view of the example poultry litter conditioner and the example attachment assembly of FIGS. 1A and 1B.

FIG. 3 is a side view of the example poultry litter conditioner and the example attachment assembly of FIGS. 1A and 1B.

FIG. 4 is a bottom view of the example poultry litter conditioner and the example attachment assembly of FIGS. 1A and 1B.

FIG. 5 is a front view of the example poultry litter conditioner and the example attachment assembly of FIGS. 1A and 1B.

FIG. 6 is a perspective view of the example poultry litter conditioner, example attachment assembly, and skid steer of FIGS. 1A and 1B in use.

FIG. 7A is a perspective view of an example poultry litter conditioner and an example attachment assembly.

FIG. 7B is a perspective view of the example poultry litter conditioner of FIGS. 1A and 1B, and yet another example attachment assembly.

FIG. 8A is a perspective view of the example attachment assembly of FIGS. 1A and 1B and an example grading blade.

FIG. 8B is a perspective view of the example attachment assembly of FIGS. 1A and 1B and an example snow blower.

Like reference symbols in the various drawings indicate like elements.

### DETAILED DESCRIPTION

Described herein are example poultry litter conditioners, and example devices, methods and systems for attaching poultry litter conditioners, or other machines or tools such as snow blowers or grading blades, to a skid steer.

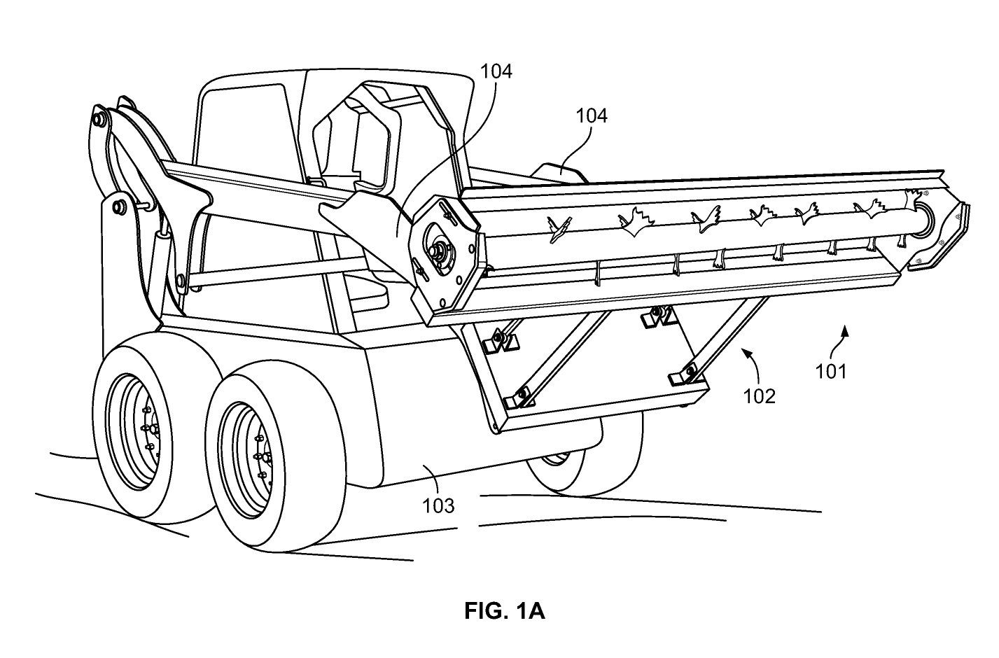

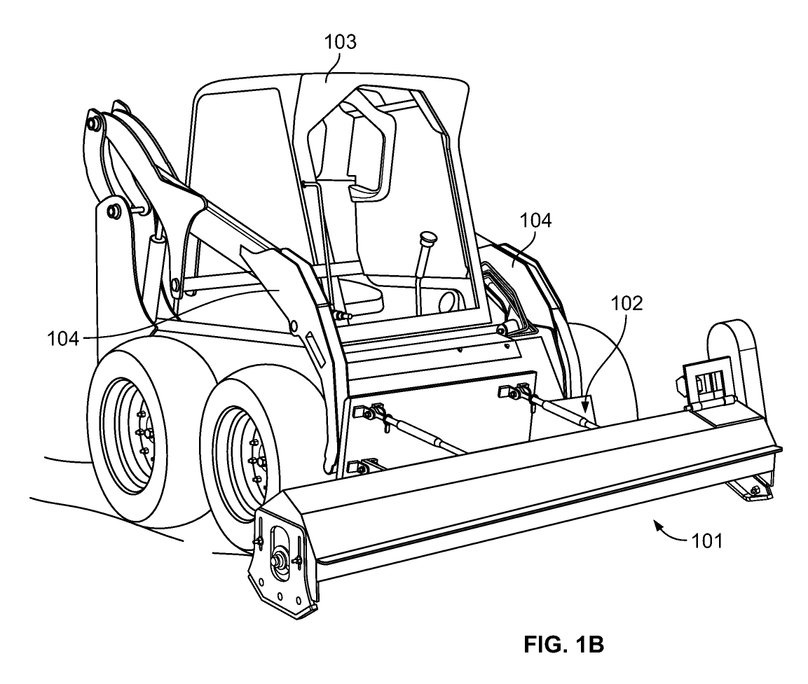

FIG. 1A is a perspective view 100 of an example poultry litter conditioner 101 and example attachment assembly 102 that can be used to attach the poultry litter conditioner 101 to an example skid steer 103. The skid steer 103 includes lift arms 104 that can be raised or lowered by an operator of the skid steer via a control in the cabin of the skid steer 103. The example attachment assembly 102 is connected to the lift arms 104 of the skid steer 103 at a first end, and is connected to the poultry litter conditioner 101 at a second end. View 100 shows the skid steer 103 with its lift arms 104 partially raised, so that the poultry litter conditioner 101 is lifted off the ground by the lift arms 104 and the attachment assembly 102. FIG. 1B is a perspective view of the example poultry litter conditioner 101, example attachment assembly 102, and example skid steer 103 of FIG. 1A, this time with the lift arms 104 lowered so that the poultry litter conditioner 101, via the attachment assembly 102, rests on the ground.

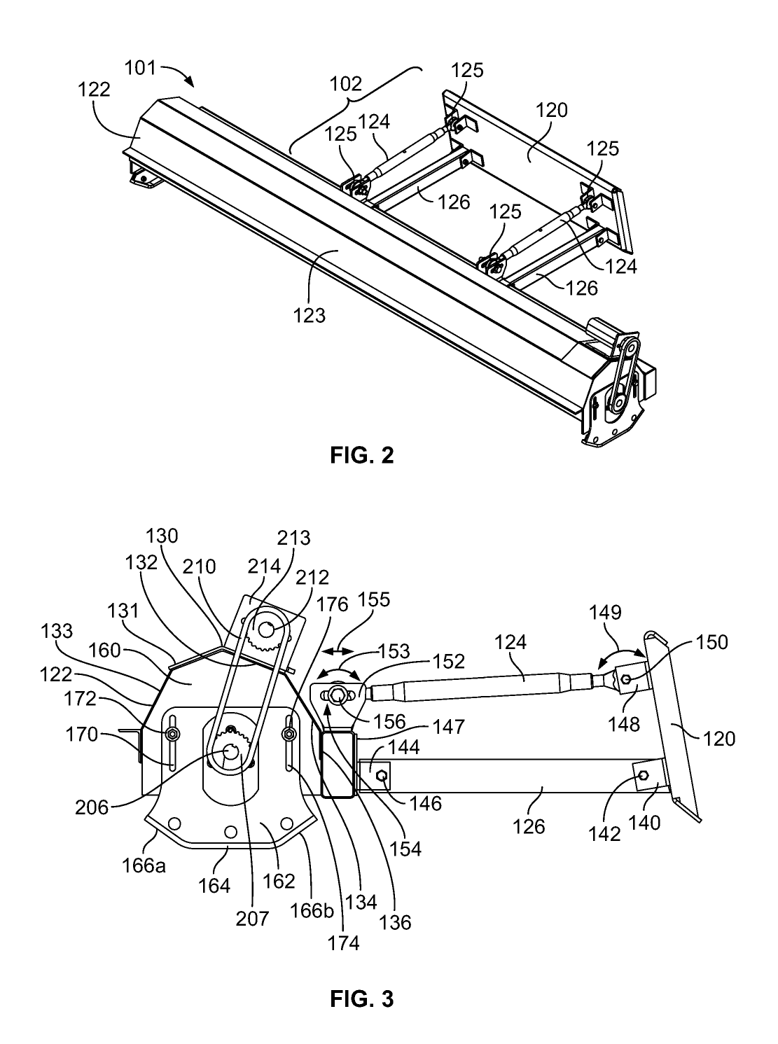

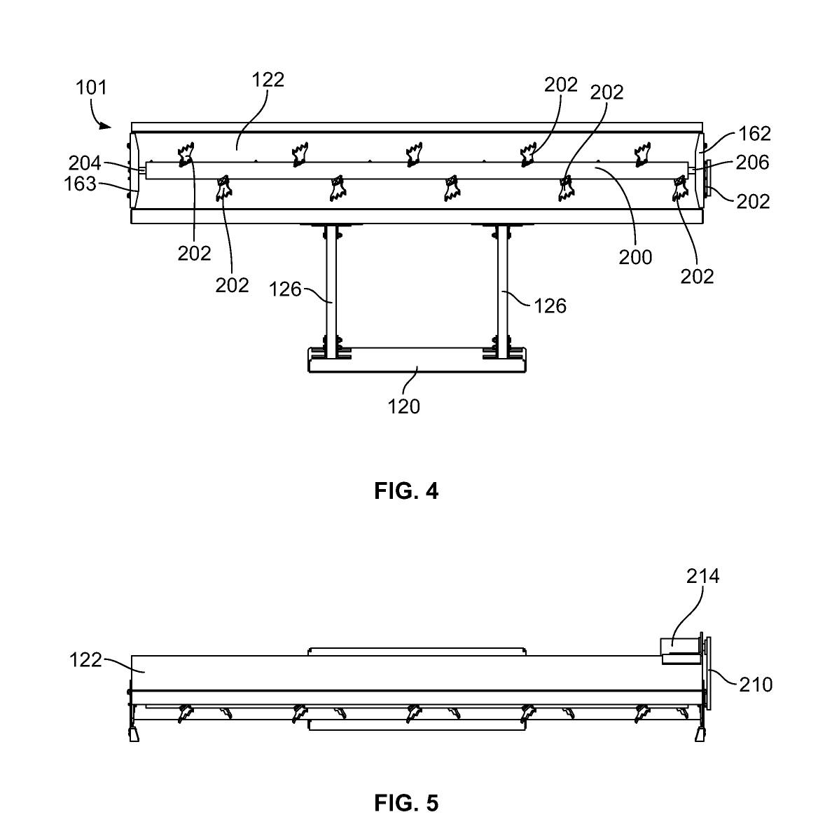

FIG. 2 is a perspective view, FIG. 3 is a side view, FIG. 4 is a bottom view, and FIG. 5 is a front view of the example poultry litter conditioner 101 and the example attachment assembly 102 of FIGS. 1A and 1B.

The example poultry litter conditioner 101 includes a tunnel assembly 122 that includes a hood 123, a left endplate 160, a right endplate, a motor 214, a shaft 200 configured to be rotated by the motor 214, a plurality of beater elements 202 attached to the shaft 200, a support bar 147 that provides support for the tunnel assembly 122, left height adjust plate 162 attached to the left endplate 160 and adjustable with respect to the left endplate 160 to set a height of the poultry litter conditioner 101, a right height adjust plate 163 attached to the right endplate and adjustable with respect to the right endplate to set a height of the poultry litter conditioner 101, and left and right replaceable wear bars attached respectively to the left height-adjust plate 162 and the right height-adjust plate 163.

The example attachment assembly 102 includes a mounting plate 120 and four (in this example) support members that connect the poultry litter conditioner 101 to the mounting plate 120. In some examples, the mounting plate 120 can be mounted to the lift arms 104 of a skid steer 103 or to a plate of the skid steer that is attached to the lift arms of the skid steer, and the support members can be attached to the mounting plate 120 at a first end of the support members. In the depicted example, the support members include two upper support members 124 and two lower support members 126. In some examples, more or fewer (e.g., one, three, four, or more) upper support members 124 may be included; similarly, more or fewer (e.g., one, three, four, or more) lower support members 126 may be included in some examples.

In various implementations, the mounting plate 120 can be attached to the lift arms 104 of the skid steer 103 in a variety of ways, as will be known to one of ordinary skill in the art. For example, the mounting plate 120 can be bolted to the lift arms 104 of the skid steer, or bolted to a plate of the skid steer that is attached to the lift arms of the skid steer, or in other appropriate ways (e.g., to one or more brackets attached to the skid steer arms). In some examples, the mounting plate 120 may have a different shape than the generally rectangular shape of the mounting plate 120 depicted in FIG. 2.

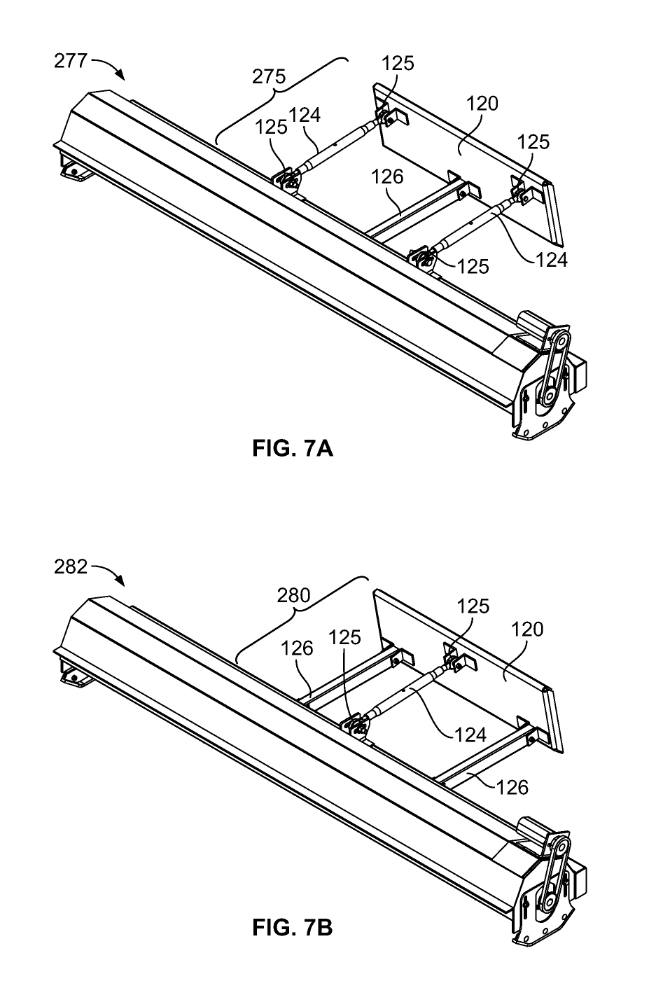

In the depicted example, the mounting plate 120 includes two upper brackets or bracket pairs 148, and two lower brackets or bracket pairs 140. Regarding each of the lower brackets 140, a first end of a lower support member 126 is attached to the respective lower bracket 140 via a bolt 142 or other appropriate connecting member (e.g., a pin). The lower support member 126 may be a rigid, elongate member, and may be attached at a first end to the mounting plate 120 (e.g., via bracket 140) and may be attached at a second end to the poultry litter conditioner 101 (e.g., at support bar 147 of the poultry litter conditioner 101), for example via a bracket or bracket pair 144 of the poultry litter conditioner 101 and secured by a bolt 146 or other appropriate connecting member (e.g., a pin), or to another machine or tool in examples where the attachment assembly 102 is used with a machine or tool other than the poultry litter conditioner 101 (see, e.g., FIGS. 7A and 7B).

In some examples, the lower support member 126 may pivot about the bolt 142 until a portion of the lower support member 126 contacts the mounting plate 120 (which may provide a pivot stop, for example). In some examples, the lower bracket 140 may be configured to provide a gap of about ⅛″ between the mounting plate 120 and the first end of the lower support member 126 in a starting position. In some examples, the lower support member 126 may pivot about the bolt 146 until a portion of the lower support member 126 contacts the support bar 147 (which may provide a pivot stop, for example). In some examples, the bracket 146 may be configured to provide a gap of about 1/16″ between the support bar 147 and the second end of the lower support member 126 in a starting position. In general, each of the two lower support members 126 may generally move independently of the other.

For each of the upper brackets or bracket pairs 148 of the mounting plate 120, an upper support member 124 is coupled to the respective upper bracket 148 via a bolt 150. The upper support member 124 is an elongate member, coupled at a first end to the mounting plate 120 (e.g., via bracket 148), and coupled at a second end to the poultry litter conditioner 101 (e.g., at support bar 147 of the poultry litter conditioner 101), or to another machine or tool in examples where the attachment assembly 102 is used with a machine or tool other than the poultry litter conditioner 101 (see, e.g., FIGS. 7A and 7B). In some examples, the upper support member 124 can include a length adjustment feature, such as a turnbuckle, that can be adjusted to set an appropriate length of the upper support member 124.

In some examples, the bolt 150 includes a ball feature, and the first end of the upper support member 124 includes a socket 125 configured to couple with the ball feature of the bolt 150 to form a ball-and-socket coupling. The first end of the upper support member 124 may pivot 149 via the ball-and-socket coupling provided by socket 125 and the ball feature of bolt 150, according to some examples. Arrow 149 in FIG. 3 depicts that the upper support member 124 may pivot in a front-to-back direction, and in some examples the upper support member 124 may also pivot laterally or may pivot a combination of front-to-back and laterally (for simplicity, arrow showing lateral pivot not shown in FIG. 3). In some examples, a pivot range of from 0-8 degrees (e.g., in any direction) may be provided by the ball-and-socket connection. In some examples, a pivot range of from 0-12 degrees (e.g., in any direction) may be provided by the ball-and-socket connection. In some examples, a larger pivot range may be provided.

In some examples, the second end of the upper support member 124 is slidably coupled to a bracket or bracket pair 152 of the poultry litter conditioner 101 via a bolt 156 positioned in a slot 154 defined by the bracket 152. Some examples of the bolt 156 include (similar to bolt 150 at the mounting plate end), a ball feature, and the second end of the upper support member 124 can include a socket 125 configured to couple with the ball feature of the bolt 156 to form a ball-and-socket coupling. The second end of the upper support member 124 may pivot 153 via the ball-and-socket coupling provided by socket 125 and the ball feature of bolt 156, according to some examples. Arrow 153 in FIG. 3 depicts that the upper support member 124 may pivot in a front-to-back direction, and in some examples the upper support member 124 may also pivot laterally (for simplicity, arrow showing lateral pivot not shown in FIG. 3). In some examples, a pivot range of from 0-8 degrees (e.g., in any direction) may be provided by the ball-and-socket connection. In some examples, a pivot range of from 0-12 degrees (e.g., in any direction) may be provided by the ball-and-socket connection. In some examples, a larger pivot range may be provided.

In the depicted example, the slot 154 has a generally horizontal orientation in bracket 152, and the bolt 156 and second end of the upper support member 124 may slide 155 forward or rearward within the slot 154, according to some examples. As such, the second end of the upper support member 124 may both pivot 153 (e.g., may pivot front-to-back, or may pivot laterally, or a combination of the foregoing) via the ball-and-socket coupling and may slide 155 forward or rearward in the slot 154, according to some examples. The slot 154 may have a variety of lengths in various implementations. In some examples, the slot 154 has a length of 3.5″. In some examples, the slot has a length of 2″, 2.5″, 3″, 4″, 4.5″, 5″, 5.5″, 6″, or longer. As a starting position, an operator may position the bolt 156 generally at or near a center of the slot 156 (e.g., as depicted in FIG. 3), so that in operation the bolt may have approximately equal amount of travel forwards in the slot 154 or rearwards in the slot 154.

In some examples, the slot 154 may have an orientation other than generally horizontal. For example, the slot may generally slope rearward or may generally slope forward (not shown). In some examples the slot may have a “V” shape or a “W” shape, or an “M” shape, for example (not shown). Other orientations for the slot are also possible.

In general, each of the two upper support members 124 may generally move independently of the other, and this can advantageously provide adjustability to permit the poultry litter conditioner to be able to tip an appropriate amount to one side or the other, or to roll an appropriate amount forward or rearward, which can provide better adaptability of the poultry litter conditioner to uneven terrain such as poultry barn floors that are uneven and have dips or mounds, for example.

Adjustability provided by one or more of the ability for the first ends of upper support members 124 to pivot (e.g., front-to-back, laterally, or a combination of the foregoing), the ability of the second ends of upper support members 124 to pivot (e.g., front-to-back, laterally, or a combination of the foregoing) and slide front-to-back within slot 154, and the ability of the first end and the second end of lower support members 126 to pivot can provide performance advantages and durability advantages in some implementations. For example, as described above many poultry barns have uneven floors whether because the concrete is uneven or has dips, holes, hills or mounds (or other irregularities) in it, or because the dirt floor is uneven or has dips, holes, hills or mounds (or other irregularities) in it, and the built-in flexibility that may be possible using the attachment assemblies discussed herein can permit the poultry litter conditioner (or other machine or tool) to better adapt to the contour of the floor or terrain over which it is being used. When the poultry litter conditioners and attachment assemblies discussed herein encounter a dip, hill, mound, or other type of irregularity in the terrain being processed, because of the adjustability and flexibility provided by the attachment assembly, the poultry litter conditioner may advantageously tip to the left or to the right, if appropriate, or may roll forward or roll backwards, if appropriate, or a combination of tipping and rolling, if appropriate, so that the poultry litter may be better reconditioned. Additionally, durability of the machine may be enhanced because wear and tear on the components of the machine may be reduced due to reduced stress or force imparted on the components of the machine as compared to the stress or force imparted to components of a more rigid machine.

For example, when the poultry litter conditioner 101 encounters a mound, hill, or other obstruction, one or more of the following may occur: a) the bolts 156 may slide rearward in the respective slots 154, which may permit the tunnel assembly to roll rearward; b) the ball-and socket connections at the second end and/or first end of the upper support members 124 may pivot, in some examples to different degrees; and/or c) the second end or first end (or both) of the lower support member 126 may pivot, in some examples to different degrees.

The poultry litter conditioner 101 includes a tunnel assembly 122 that includes a hood 123, a left endplate 160, a right endplate opposite the left endplate 160, a motor 214, a shaft 200 configured to be rotated by the motor 214, a plurality of beater elements 202 attached to the shaft 200, a support bar 147 that provides support for the tunnel assembly 122, a left height adjust plate 162 attached to the left endplate 160 and adjustable with respect to the left endplate 160 to set a height of the poultry litter conditioner 101, a right height adjust plate 163 attached to the right endplate and adjustable with respect to the right endplate to set a height of the poultry litter conditioner 101, and left and right replaceable wear bars attached respectively to lower portions of the left height-adjust plate 162 and the right height-adjust plate 163. In operation, the motor 214 causes the shaft 200 to rotate, thereby causing the plurality of beaters 202 to also rotate. The beaters 202 condition the poultry litter by lifting the poultry litter from the floor of the poultry barn and propelling the poultry litter against the underside of the hood 123 or against the left or right endplate. The poultry litter is thus aerated and broken up by the action of the beaters 202 and by collision with the underside of the hood 123 or with one of the endplates. In some examples, the poultry litter rebounds off the underside of the hood 123 or off an endplate and is again (in some examples, repeatedly) beaten by the beaters 202, which may further condition the poultry litter. Eventually, the conditioned poultry litter returns to the floor of the poultry barn, exiting below and behind the support bar 147 as the skid steer 103 is driven forward.

The hood 123 can have a variety of shapes. In the depicted examples, the hood 123 includes an apex 130 of the hood 123, a first forward surface 131 of the hood 123, a first rearward surface 132 of the hood 123, a second forward surface 133 of the hood 123, a second rearward surface 134 of the hood 123, a third forward surface 135 of the hood 123 and a third rearward surface 136 of the hood 123. The apex 130 is formed by the intersection of the first forward surface 131 and the first rearward surface 132, which intersect at a first obtuse angle. The first forward surface 131 and the second forward surface 133 intersect at a second obtuse angle that is greater than the first obtuse angle. Also, the first rearward surface 132 and the second rearward surface 134 intersect at a third obtuse angle that is greater than the first obtuse angle. The second forward surface 133 and the third forward surface 135 intersect at a fourth obtuse angle, and the second rearward surface 134 and the third rearward surface 136 intersect at a fifth obtuse angle.

The shape of the hood 123, the surfaces 131, 132, 133, 134, 135, and 136, and the angles defined by the surfaces of the hood 123 may advantageously encourage additional conditioning of the poultry litter. For example, when the beaters 202 propel the poultry litter against the underside of the hood 123, the poultry litter may bounce off the underside of the hood 123 and be directed back towards the beaters 202, which may cause the poultry litter to again be propelled against the underside of the hood 123. This may be repeated several times, for example, which may improve the reconditioning of the poultry litter in some examples.

In some examples, the hood 123 may comprise a single sheet of metal that is bent to have the depicted shape with the surfaces 131-136 and the described obtuse angles. The multiple surfaces 131-136 may provide increased strength to the hood as compared to hoods with fewer surfaces, for example. In some examples, the support bar 147 may be welded to the tunnel assembly, and the brackets or bracket pairs 152 and 144 may be welded to the support bar (e.g., to an upper surface of the support bar and to a rear-facing surface of the support bar, respectively). The left and right endplates may be welded to the hood 123, for example.

In some examples, the motor 214 can be mounted to a portion of the hood 123, perhaps with one or more brackets or strengthening panels for added support. The motor 214 is coupled to the shaft 200 via a belt 210 (or in some examples a chain). A first sprocket or gear 213 is coupled to a shaft 212 of the motor, and a second sprocket or gear 207 is coupled to an end portion 206 of the shaft 200, with the belt 210 coupling the first sprocket 213 to the second sprocket 207. Sprocket ratios can be altered to obtain an appropriate shaft rotation velocity, as will be known to one or skill in the art.

The left height-adjust plate 162 is bolted to the left endplate 160 via a left-rear height-adjust bolt 176 and a left-front height-adjust bolt 172. The left-rear height adjust bolt 176 can be adjusted and secured within a vertical rear slot 174 defined by the left height-adjust plate 162 to adjust a left-rear height of the poultry litter conditioner. Similarly, the left-front height adjust bolt 172 can be adjusted and secured within a vertical front slot 170 defined by the left height-adjust plate 162 to adjust a left-front height of the poultry litter conditioner. The right height-adjust plate 163 includes similar height adjustability (not shown). The height adjustment can be used to set a desired depth for the processed poultry litter. In some examples, a depth of 2″, 2.5″, 3″, 3.5″, 4″, 4.5″, 5″, 5.5″, 6″, or greater may be desired, for example.

Attached to a lower portion of the left height-adjust plate 162 is a replaceable wear bar 164, which can be replaced over time as it wears down, and the right height-adjust plate 163 similarly includes a replaceable wear bar attached on a lower portion. As can be seen with reference to FIG. 3, the height adjust plate includes an angled forward lower edge 166a, an angled rearward lower edge 166b, and a lower edge 164. The angled forward and rearward lower edges 166a, 166b may aid in traversing floors with varying contours, for example.

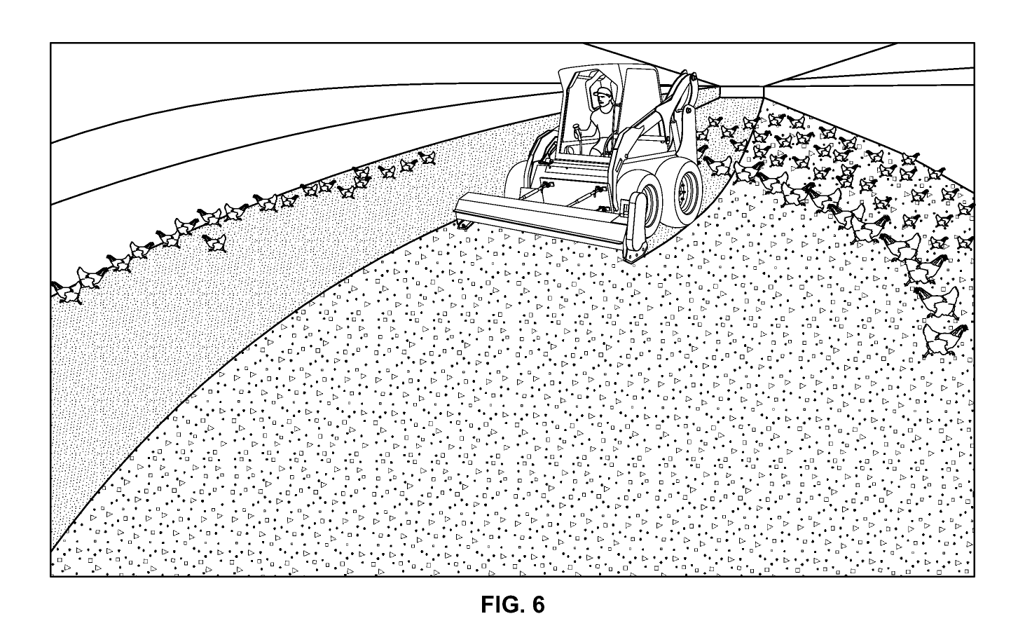

FIG. 6 is a perspective view of the example poultry litter conditioner 101, example attachment assembly 102, and skid steer 103 of FIGS. 1A and 1B in use. An operator using the poultry litter conditioner 101, which is attached to the skid steer 103 via the attachment assembly 102 to recondition the poultry litter on the floor of the poultry barn.

FIG. 7A is a perspective view of an example poultry litter conditioner 277 and an example attachment assembly 275. The example attachment assembly 275 is similar to the example attachment assembly 102, except that attachment assembly 275 includes a single lower support member 126 rather than two lower support members. Similarly, poultry litter conditioner 277 is very similar to the poultry litter conditioner 101 discussed above, except that only a single lower bracket (e.g., similar to bracket 144 (see FIG. 3) is included because the attachment assembly 275 includes a single lower support member 126. The mounting plate 120 may be mounted to a skid steer 103 (see e.g., FIG. 1A).

FIG. 7B is a perspective view of an example poultry litter conditioner 282 and an example attachment assembly 280. The example attachment assembly 280 is similar to the example attachment assembly 102 described above, except that attachment assembly 280 includes a single upper support member 124 rather than two upper support members. Similarly, poultry litter conditioner 282 is very similar to the poultry litter conditioner 101 discussed above, except that only a single upper bracket (e.g., similar to bracket 152 (see FIG. 3) is included because the attachment assembly 280 includes a single upper support member 124. The mounting plate 120 may be mounted to a skid steer 103 (see e.g., FIG. 1A).

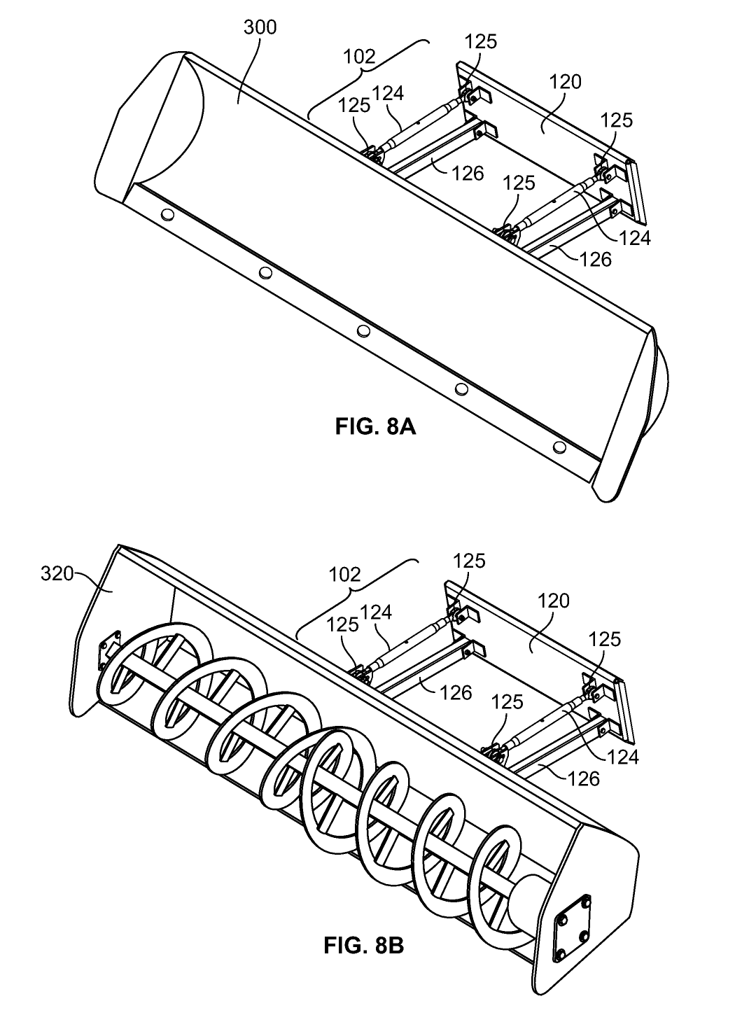

FIG. 8A is a perspective view of the example attachment assembly 102 of FIGS. 1A and 1B and an example grading blade 300. The grading blade 300 and attachment assembly 102 can be mounted to a skid steer 103 (see e.g., FIG. 1A) and used to grade a road, for example. In other examples, the grading blade 300 could be attached to the attachment assembly 275 of FIG. 7A, or to the attachment assembly 280 of FIG. 7B.

FIG. 8B is a perspective view of the example attachment assembly 102 of FIGS. 1A and 1B and an example snow blower 320. The snow blower 320 and attachment assembly 102 can be mounted to a skid steer 103 (see e.g., FIG. 1A) and used to blow snow from a driveway or parking lot, for example. In other examples, the grading snow blower 320 could be attached to the attachment assembly 275 of FIG. 7A, or to the attachment assembly 280 of FIG. 7B.

The above description provides examples of some implementations. Other implementations that are not explicitly described above are also possible, such as implementations based on modifications and/or variations of the features described above. For example, the techniques described above may be implemented in different orders, with the inclusion of one or more additional steps, and/or with the exclusion of one or more of the identified steps. Similarly, the apparatuses described herein may include one or more additional features, may exclude one or more of the identified features, and/or include the identified features combined in a different way than presented above. Features that are described as singular may be implemented as a plurality of such features. Likewise, features that are described as a plurality may be implemented as singular instances of such features. The drawings are intended to be illustrative and may not precisely depict some implementations. Variations in sizing, placement, shapes, angles, curvatures, and/or the positioning of features relative to each other are possible. Accordingly, other implementations are within the scope of the following claims.

What is claimed is:

1. A poultry litter conditioner, comprising:
a tunnel assembly that includes a hood, a left endplate, and a right endplate;
a motor;
a shaft configured to be rotated by the motor, a majority of the shaft disposed between the left endplate and the right endplate;
a plurality of beater elements attached to the shaft; and
an attachment assembly that includes a mounting plate configured to attach to a skid steer, the attachment assembly further including first and second lower support members, each coupled to the mounting plate and to the tunnel assembly, and including first and second upper support members, each coupled to the mounting plate and to the tunnel assembly;
wherein the first upper support member is coupled to the tunnel assembly via a first ball-and-socket connection, the first ball-and-socket connection comprising a first bolt and a first bracket that defines a first slot, wherein at least a portion of the first bolt is slidably disposed within the first slot, and wherein the first bracket is attached to the tunnel assembly; and
wherein the second upper support member is coupled to the tunnel assembly via a second ball-and-socket connection, the second ball-and-socket connection comprising a second bolt and a second bracket that defines a second slot, wherein at least a portion of the second bolt is slidably disposed within the second slot, and wherein the second bracket is attached to the tunnel assembly.

2. The poultry litter conditioner of claim 1, wherein the tunnel assembly further includes a support bar, and wherein each of the first bracket and the second bracket are attached to the support bar.

3. The poultry litter conditioner of claim 1, wherein the first upper support member is coupled to the mounting plate via a third ball-and-socket connection, and wherein the second upper support member is coupled to the mounting plate via a fourth ball-and-socket connection.

4. The poultry litter conditioner of claim 1, wherein the first lower support member is coupled to the mounting plate via a third bracket and a third bolt, the first lower support member able to pivot about the third bolt until a portion of the first lower support member contacts the mounting plate; and wherein the second lower support member is coupled to the mounting plate via a fourth bracket and a fourth bolt, the second lower support member able to pivot about the fourth bolt until a portion of the second lower support member contacts the mounting plate.

5. The poultry litter conditioner of claim 1, wherein the hood of the tunnel assembly includes a first forward surface and a first rearward surface that are joined at an apex of the hood, the hood further including a second forward surface contiguous with the first forward surface and including a second rearward surface contiguous with the first rearward surface, the tunnel assembly further including a third forward surface contiguous with the second forward surface and including a third rearward surface contiguous with the second rearward surface.

6. The poultry litter conditioner of claim 5, wherein the first forward surface and the first rearward surface intersect at a first obtuse angle; wherein the first forward surface and the second forward surface intersect at a second obtuse angle; wherein the first rearward surface and the second rearward surface intersect at a third obtuse angle; wherein the second forward surface and the third forward surface intersect at a fourth obtuse angle; and wherein the second rearward surface and the third rearward surface intersect at a fifth obtuse angle.

7. The poultry litter conditioner of claim 5, wherein first ends of each of the first, second and third forward surfaces and first, second and third rearward surfaces are attached to the left end plate, and wherein second ends of each of the first, second and third forward surfaces and first, second and third rearward surfaces are attached to the right end plate.

8. The poultry litter conditioner of claim 1, wherein the mounting plate is configured to attach to one or more lift arms of the skid steer.

9. The poultry litter conditioner of claim 1, wherein the mounting plate is configured to attach to a plate that is attached to one or more lift arms of the skid steer.

10. The poultry litter conditioner of claim 1, further comprising a first height-adjust plate attached to the left endplate and a second height-adjust plate attached to the right endplate, wherein a height of the tunnel assembly is adjustable by setting a position of the first height-adjust plate with respect to the left endplate and by setting a position of the second height-adjust plate with respect to the right endplate.

11. The poultry litter conditioner of claim 10, further comprising first and second replaceable wear bars, the first replaceable wear bar attached to a lower portion of the first height-adjust plate, and the second replaceable wear bar attached to a lower portion of the second height-adjust plate.

12. The poultry litter conditioner of claim 1, wherein the first slot defined by the first bracket has a horizontal orientation, and wherein the second slot defined by the second bracket has a horizontal orientation.

13. A poultry litter conditioner, comprising:
a tunnel assembly that includes a hood, a left endplate, and a right endplate;
a motor;
a shaft configured to be rotated by the motor, a majority of the shaft disposed between the left endplate and the right endplate;
a plurality of beater elements attached to the shaft; and
an attachment assembly that includes a mounting plate configured to attach to a skid steer, the attachment assembly further including first and second lower support members, each coupled to the mounting plate and to the tunnel assembly, and an upper support member coupled to the mounting plate and to the tunnel assembly;
wherein the upper support member is coupled to the tunnel assembly via a ball-and-socket connection, the ball-and-socket connection comprising a bolt and a bracket that defines a slot, wherein at least a portion of the bolt is slidably disposed within the slot, and wherein the bracket is attached to the tunnel assembly.

14. The poultry litter conditioner of claim 13, wherein the tunnel assembly further includes a support bar, and wherein the first bracket is attached to the support bar.

15. The poultry litter conditioner of claim 13, wherein the upper support member is coupled to the mounting plate via a second ball-and-socket connection.

16. The poultry litter conditioner of claim 13, wherein the first lower support member is coupled to the mounting plate via a second bracket and a second bolt, the first lower support member able to pivot about the second bolt until a portion of the first lower support member contacts the mounting plate; and wherein the second lower support member is coupled to the mounting plate via a third bracket and a third bolt, the second lower support member able to pivot about the third bolt until a portion of the second lower support member contacts the mounting plate.

17. A poultry litter conditioner, comprising:
a tunnel assembly that includes a hood, a left endplate, and a right endplate;
a motor;
a shaft configured to be rotated by the motor, a majority of the shaft disposed between the left endplate and the right endplate;
a plurality of beater elements attached to the shaft; and
an attachment assembly that includes a mounting plate configured to attach to a skid steer, the attachment assembly further including a lower support member coupled to the mounting plate and to the tunnel assembly, and including first and second upper support members, each coupled to the mounting plate and to the tunnel assembly;
wherein the first upper support member is coupled to the tunnel assembly via a first ball-and-socket connection, the first ball-and-socket connection comprising a first bolt and a first bracket that defines a first slot, wherein at least a portion of the first bolt is slidably disposed within the first slot, and wherein the first bracket is attached to the tunnel assembly; and
wherein the second upper support member is coupled to the tunnel assembly via a second ball-and-socket connection, the second ball-and-socket connection comprising a second bolt and a second bracket that defines a second slot, wherein at least a portion of the second bolt is slidably disposed within the second slot, and wherein the second bracket is attached to the tunnel assembly.

18. The poultry litter conditioner of claim 17, wherein the tunnel assembly further includes a support bar, and wherein each of the first bracket and the second bracket are attached to the support bar.

19. The poultry litter conditioner of claim 17, wherein the first upper support member is coupled to the mounting plate via a third ball-and-socket connection, and wherein the second upper support member is coupled to the mounting plate via a fourth ball-and-socket connection.

20. The poultry litter conditioner of claim 17, wherein the lower support member is coupled to the mounting plate via a third bracket and a third bolt, the lower support member able to pivot about the third bolt until a portion of the lower support member contacts the mounting plate.
